(19) United States
(12) Patent Application Publication
(10) Pub. No.: US 2025/0007654 A1
(43) Pub. Date: Jan. 2, 2025

(54) REPETITION REQUEST FOR COVERAGE ENHANCEMENT

(71) Applicant: QUALCOMM Incorporated, San Diego, CA (US)

(72) Inventors: Qiaoyu LI, Beijing (CN); Wooseok NAM, San Diego, CA (US); Mahmoud TAHERZADEH BOROUJENI, San Diego, CA (US); Tao LUO, San Diego, CA (US); Iyab Issam SAKHNINI, San Diego, CA (US)

(21) Appl. No.: 18/292,835

(22) PCT Filed: Sep. 10, 2021
(86) PCT No.: PCT/CN2021/117589

§ 371 Date: Jan. 26, 2024

(51) Int. Cl. H04L 1/1867; H04W 74/00; H04W 74/0833

(52) U.S. Cl. CPC H04L 1/1893; H04W 74/004; H04W 74/0833

(57) ABSTRACT

Methods, apparatuses, and computer-readable medium for reducing signaling overhead for a RedCap UE are provided. An example method may include receiving, from a base station, a grant associated with a set of random access channel (RACH) resources, a first part of the set of RACH resources for a reduced capability report including a set of overlapping resources that overlaps with a second part of the set of RACH resources for a physical uplink shared channel (PUSCH) repetition request. The example method may further include transmitting, in the set of overlapping resources to the base station, one or more repetition requests or one or more repetition number indications.

### TECHNICAL FIELD

The present disclosure relates generally to communication systems, and more particularly, to wireless communication systems with random access channel (RACH) and physical uplink shared channel (PUSCH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a base station, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. The memory and the at least one processor coupled to the memory may be further configured to transmit, in the set of overlapping resources to the base station, one or more repetition requests or one or more repetition number indications.

In another aspect of the disclosure, a method, a computer-readable medium, and an apparatus at a base station are provided. The apparatus may include a memory and at least one processor coupled to the memory. The memory and the at least one processor coupled to the memory may be configured to transmit, to a UE, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. The memory and the at least one processor coupled to the memory may be further configured to receive, in the set of overlapping resources from the UE, one or more repetition requests or one or more repetition number indications.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a base station in communication with a UE in a RACH procedure.

FIG. 5 is a diagram illustrating RACH resources for reduced capability (RedCap) and RACH resources for Msg 3 repetition request that may be overlapping.

FIG. 6 is a diagram illustrating a base station in communication with a UE in a RACH procedure with repetitions.

FIG. 7 is a diagram illustrating using overlapping resources between RACH resources for RedCap and RACH resources for coverage enhancement for indicating repetition.

FIG. 8 is a diagram illustrating enable or disable of using overlapping resources.

FIG. 9 is a diagram illustrating using overlapping resources between RACH resources for RedCap and RACH resources for coverage enhancement for indicating repetition and new configuration for Msg2/3/4.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus.

FIG. 15 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

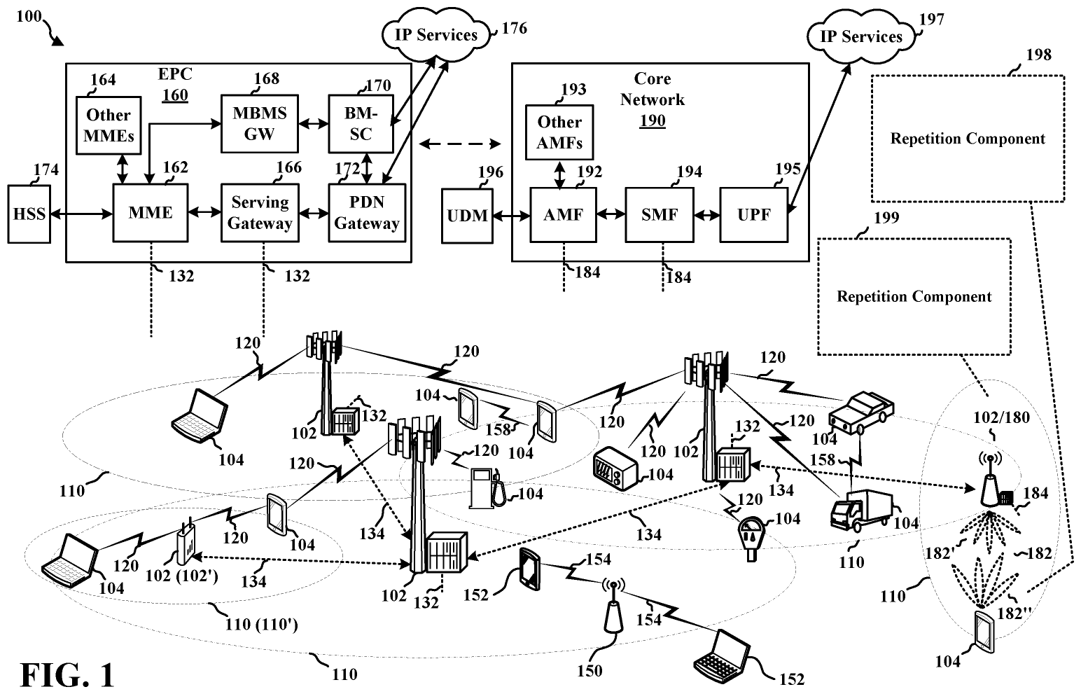

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a repetition component 198. In some aspects, the repetition component 198 may be configured to receive, from a base station, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. In some aspects, the repetition component 198 may be further configured to transmit, in the set of overlapping resources to the base station, one or more repetition requests or one or more repetition number indications.

In certain aspects, the base station 180 may include a repetition component 199. In some aspects, the repetition component 199 may be configured to transmit, to a UE, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. In some aspects, the repetition component 199 may be further configured to receive, in the set of overlapping resources from the UE, one or more repetition requests or one or more repetition number indications.

Although the following description may be focused on 5G NR, the concepts described herein may be applicable to other similar areas, such as LTE, LTE-A, CDMA, GSM, and other wireless technologies.

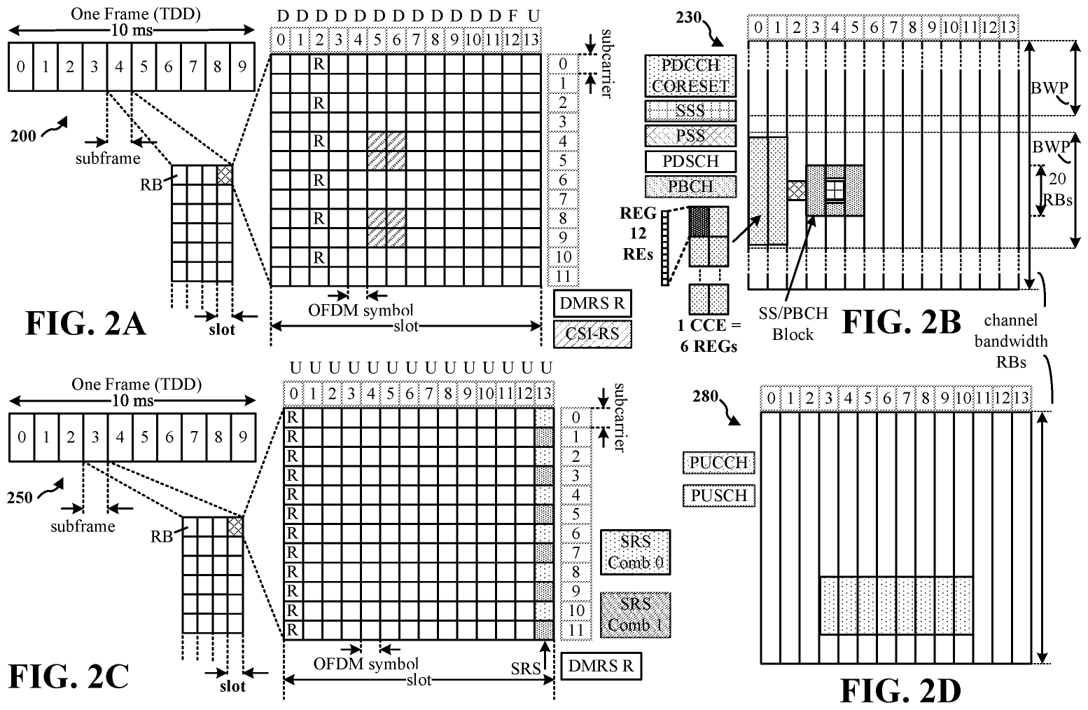

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

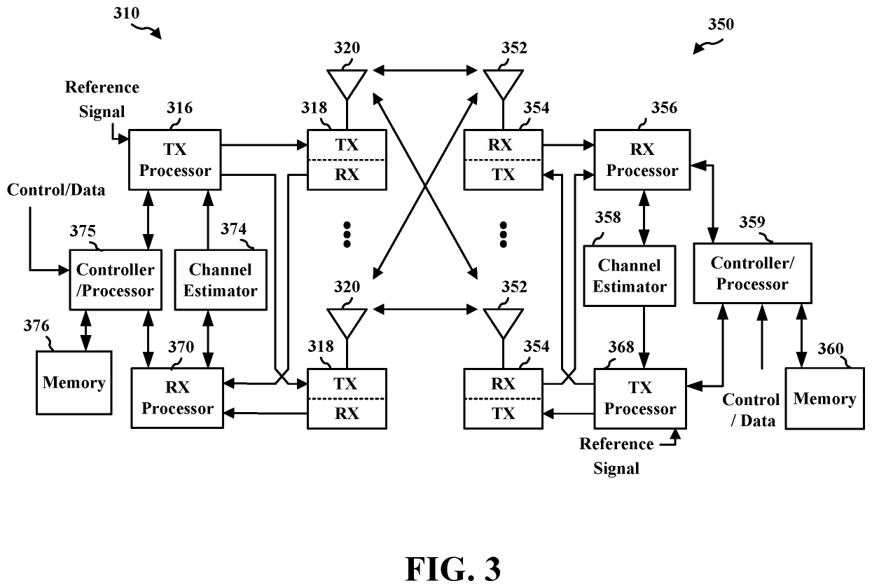

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the repetition component 198 of FIG. 1.

At least one of the TX processor 316, the RX processor 370, and the controller/processor 375 may be configured to perform aspects in connection with the repetition component 199 of FIG. 1.

In addition to higher capability devices, wireless communication may support reduced capability (RedCap) devices (may otherwise be referred as reduced capability UE or RedCap UE). Among others, examples of higher capability devices include premium smartphones, V2X devices, URLLC devices, eMBB devices, etc. Among other examples, RedCap devices may include wearables, industrial wireless sensor networks (IWSN), surveillance cameras, low-end smartphones, etc. For example, NR communication systems may support both higher capability devices and reduced capability devices. A RedCap UE may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In some examples, a reduced capability UE may have reduced transmission bandwidth or reception bandwidth than other UEs. For instance, a reduced capability UE may have a limited bandwidth of 20 MHz BWP in FR1 and/or 100 MHz in FR2. In some aspects, the reduced capability UE may have an operating bandwidth between 5 MHz and 20 MHz for both transmission and reception, in contrast to other UEs which may have a bandwidth of up to 100 MHz or more than 100 MHz. As a further example, a reduced capability UE may have a reduced number of reception antennas (e.g., 2 reception antennas) in comparison to other UEs that may have a larger number of reception antennas. For instance, a reduced capability UE may have a smaller number of receive antenna, or two receive antennas, and may experience a lower equivalent receive signal to noise ratio (SNR) in comparison to higher capability UEs that may have additional antennas. Reduced capability UEs may also have reduced computational complexity than other UEs.

A UE may use a random access procedure in order to communicate with a base station. For example, the UE may use the random access procedure to request an radio resource control (RRC) connection, to re-establish an RRC connection, resume an RRC connection, etc. A UE may use a random access procedure in order to communicate with a base station. For example, the UE may use the random access procedure to request an RRC connection, to re-establish an RRC connection, resume an RRC connection, etc. Random Access Procedures may include two different random access procedures, e.g., The UE may use Contention Based Random Access (CBRA) may be performed when a UE is not synchronized with a base station, and the Contention Free Random Access (CFRA) may be applied, e.g., when the UE was previously synchronized to a base station 604. Both the procedures include transmission of a RACH preamble from the UE to the base station. In CBRA, a UE may randomly select a RACH preamble sequence, e.g., from a set of RACH preamble sequences. As the UE randomly selects the RACH preamble sequence, the base station may receive another RACH preamble from a different UE at the same time. Thus, CBRA provides for the base station to resolve such contention among multiple UEs. In CFRA, the network may allocate a RACH preamble sequence to the UE rather than the UE randomly selecting a RACH preamble sequence. This may help to avoid potential collisions with a RACH preamble from another UE using the same sequence. Thus, CFRA is referred to as “contention free” random access.

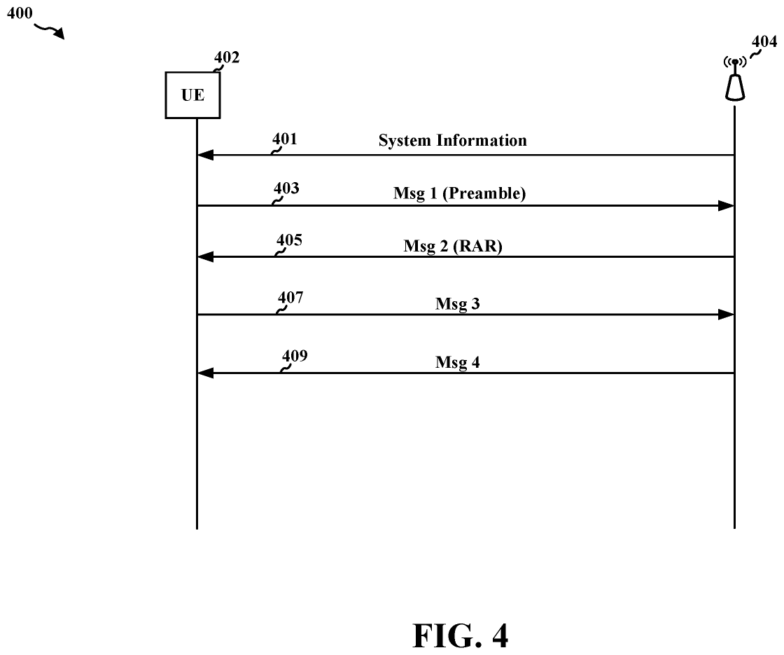

FIG. 4 illustrates example aspects of a random access procedure 400 between a UE 402 and a base station 404. The UE 402 may initiate the random access message exchange by sending, to the base station 404, a first random access message 403 (e.g., Msg 1) including a RACH preamble. Prior to sending the first random access message 403, the UE may obtain random access parameters (which may be otherwise referred to as PRACH configurations), e.g., including RACH preamble format parameters, time and frequency resources, parameters for determining root sequences and/or cyclic shifts for a RACH preamble, etc., e.g., in system information 401 from the base station 404. The RACH preamble may be transmitted with an identifier, such as a Random Access RNTI (RA-RNTI). The UE 402 may randomly select a RACH preamble sequence, e.g., from a set of RACH preamble sequences. If the UE 402 randomly selects the RACH preamble sequence, the base station 404 may receive another RACH preamble from a different UE at the same time. In some examples, a RACH preamble sequence may be assigned to the UE 402.

The base station may respond to the first random access message 403 by sending a second random access message 405 (e.g. Msg 2) using PDSCH and including a random access response (RAR). The RAR may include, e.g., an identifier of the RACH preamble sent by the UE, a time advance (TA), an uplink grant for the UE to transmit data, cell radio network temporary identifier (C-RNTI) or other identifier, and/or a back-off indicator. Upon receiving the RAR (e.g., 405), the UE 402 may transmit a third random access message 407 (e.g., Msg 3) to the base station 404, e.g., using PUSCH, that may include a RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs sent a same RACH preamble at 703, both UEs may receive the RAR leading both UEs to send a third random access message 407. The base station 404 may resolve such a collision by being able to decode the third random access message from only one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the RAR (e.g., 405).

If the UE 402 is a RedCap UE, the UE 402 may indicate in the first random access message 403 that the UE 402 is a RedCap UE. The indication of RedCap UE in the first random access message 403 may be enabled or disabled. For example, the base station may enable or disable the indication in the system information 401. Based on the UE 402 being a RedCap UE, the base station 404 may configure RACH resources for the UE 402 differently. For example, the base station 404 may configure RACH resources based on the information that the UE 402 is a RedCap UE and accordingly transmit the second random access message 405, including the RACH response.

In some aspects, the UE 402 may request a Msg 3 PUSCH repetition. If the UE 402 is a RedCap UE, the UE 402 may use a separate RACH preamble, in the first random access message 403, with shared random access occasion (RO) configured by the same PRACH configuration index configured for a non-RedCap UE. In some aspects, if the UE 402 is a RedCap UE, a PRACH mask may be introduced to indicate a sub-set of ROs associated with the same SSB index within an SSB-RO mapping cycle for requesting Msg3 repetition for the UE 402. In some aspects, a PRACH mask may not be introduced to indicate a sub-set of ROs associated with the same SSB index within an SSB-RO mapping cycle for requesting Msg3 repetition for the UE 402.

In some aspects, if the UE 402 is a RedCap UE, separate RO configured by a separate PRACH configuration index (e.g., not configured for a non-RedCap UE) may be used. In some aspects, if the UE 402 is a RedCap UE, remaining RO that are not used by a non-RedCap UE, configured by the same PRACH configuration index configured for the non-RedCap UE, may be used for the RACH preamble in the first random access message 403 for the UE 402.

In some aspects, to enable/support that the RO associated with the best SSB falls within the RedCap UE bandwidth, separate initial UL BWP for RedCap UEs (which may not be expected to exceed the maximum RedCap UE bandwidth) may be configured. In some aspects, the separate initial UL BWP for RedCap may include ROs for RedCap UEs. The ROs for RedCap UEs may be dedicated for RedCap UEs or shared with non-RedCap UEs.

Because resources including a shared RO configured by the same PRACH configuration index configured for non-RedCap UEs may be used by a RedCap UE for a Msg 3 repetition request, such resources may also be used by non-RedCap UEs for a 4-step RACH (which may be without repetitions) or a 2-step RACH (which may be without repetitions) without repetitions. Therefore, the shared RO may be defined to avoid conflict. For example, the shared RO for requesting Msg3 PUSCH repetition may be an RO with RACH preamble(s) for 4-step RACH only or an RO with RACH preambles for both 4-step RACH and 2-step RACH. Whether an RO with RACH preamble(s) for 4-step RACH only or an RO with RACH preambles for both 4-step RACH and 2-step RACH is used can be indicated to the RedCap UE.

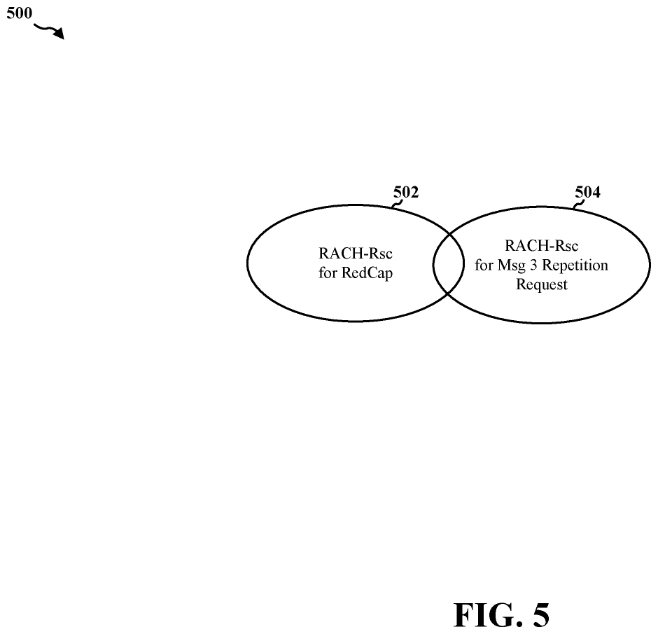

In some wireless communication systems, a coverage may be improved through a Msg 3 PUSCH repetition request. Other repetitions requests or repetition number indication (that may indicate a repetition number preference for a UE) associated with Msg 2 PDCCH or PDSCH repetition, Msg 3 PUSCH repetition, or Msg 4 PDCCH/PDSCH/PUCCH repetition may also be supported. Providing dedicated signaling and resources to support such repetition requests may increase overhead. Some example aspects provided herein may reduce signaling overhead for a UE to indicate a request for repetitions requests of random access messages and/or to indicate a repetition number for random access messages, thereby improving communication efficiency. In some aspects, the UE may use RACH resources that overlap between resources for a RedCap capabilities report and resources for another indication, e.g., resources for a coverage enhancement (CovEnh) such as a Msg 3 PUSCH repetition request, to implicitly indicate additional repetition requests or repetition number indications. For example, FIG. 5 is a diagram 500 illustrating RACH resources 502 for a RedCap UE and RACH resources 504 for a Msg 3 repetition request that may be overlapping. To improve communication efficiency, overlapping region of the RACH resources 502 and the RACH resources 504 may be used to implicitly indicate additional repetition requests or repetition number indications. The overlapping region may refer to time resources and frequency resources, ROs, or RACH preambles, that are configured for both a RedCap capabilities report and for a Msg3 repetition request.

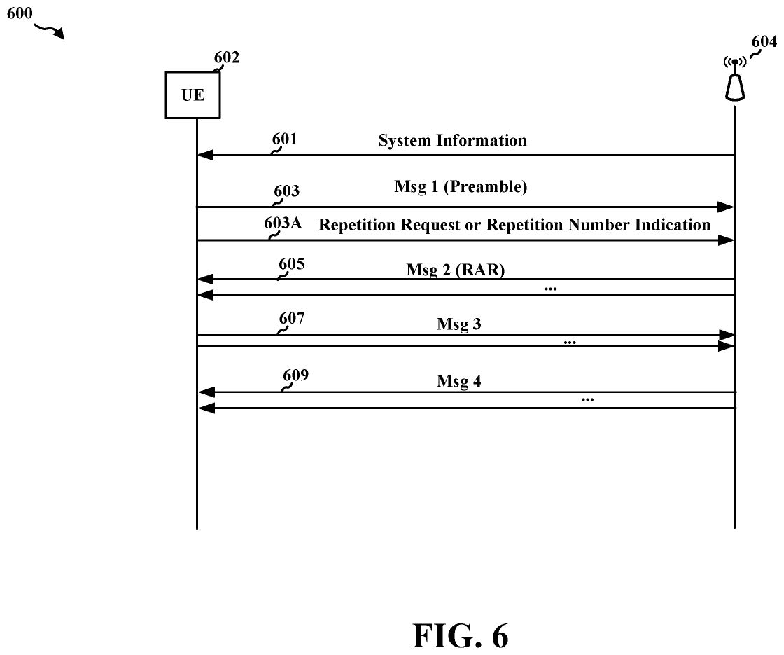

FIG. 6 is a diagram 600 illustrating a base station in communication with a UE in a RACH procedure with repetitions.

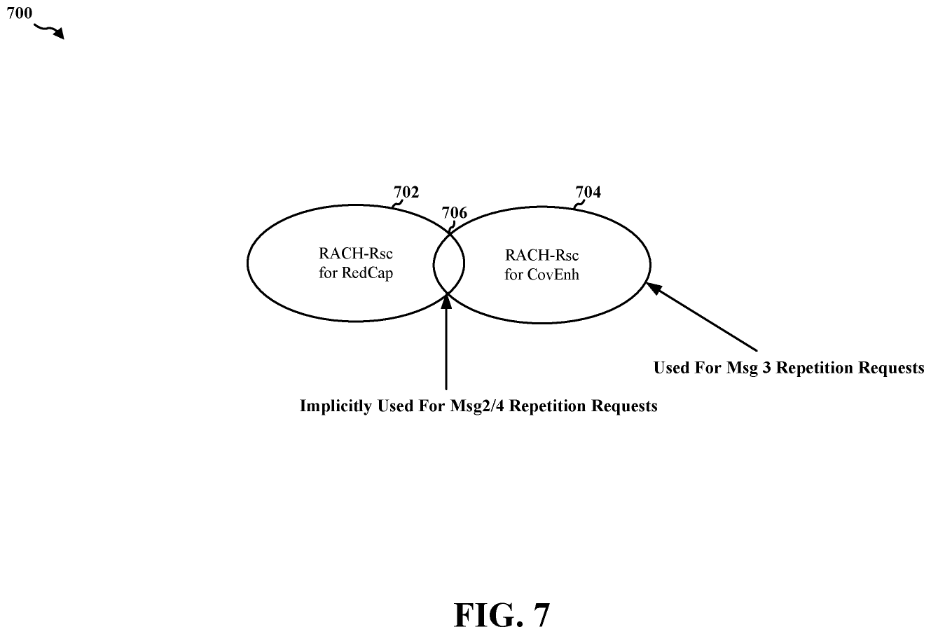

The UE 602 may initiate the random access message exchange by sending, to the base station 404, a first random access message 603 (e.g., Msg 1) including a RACH preamble. Prior to sending the first random access message 603, the UE may obtain random access parameters (which may be otherwise referred to as PRACH configurations), e.g., including RACH preamble format parameters, time and frequency resources, parameters for determining root sequences and/or cyclic shifts for a RACH preamble, etc., e.g., in system information 601 from the base station 404. The RACH preamble may be transmitted with an identifier, such as an RA-RNTI. The UE 602 may be a RedCap UE and may be configured with a first part of RACH resources for RedCap capabilities report that is at least partly overlapped with a second part of RACH resources for Msg3-PUSCH repetition request. The UE 602 may use the overlapping resources to transmit a repetition request or repetition number indication 603A. For example, as illustrated in example 700 of FIG. 7, the UE 602 may use overlapping resources 706 between RACH resources 702 for RedCap and RACH resources 704 for coverage enhancement to indicate repetition. The overlapping resources 706 may be used to implicitly indicate additional repetition requests or repetition number indication, such as Msg 2 PDCCH/PDSCH repetition request, Msg 2 PDCCH/PDSCH repetition number indication, Msg 3 PUSCH repetition number indication, Msg 4 PDCCH/PDSCH/PUCCH repetition request, or Msg 4 PDCCH/PDSCH/PUCCH repetition number indication. In some aspects, the UE 602 may be a RedCap UE and associated with at least one of: a reduced bandwidth, a reduced number of reception antennas, or half-duplex-frequency division duplex (HD-FDD). In some aspects, the UE 602 may be a RedCap UE and associated with at least one of: a reduced transmission power, a reduced reception antenna gain, a non-reduced number of reception antennas associated with a reduced number of reception chains, reduced HARQ processing capabilities, or reduced CSI processing or beam management capabilities.

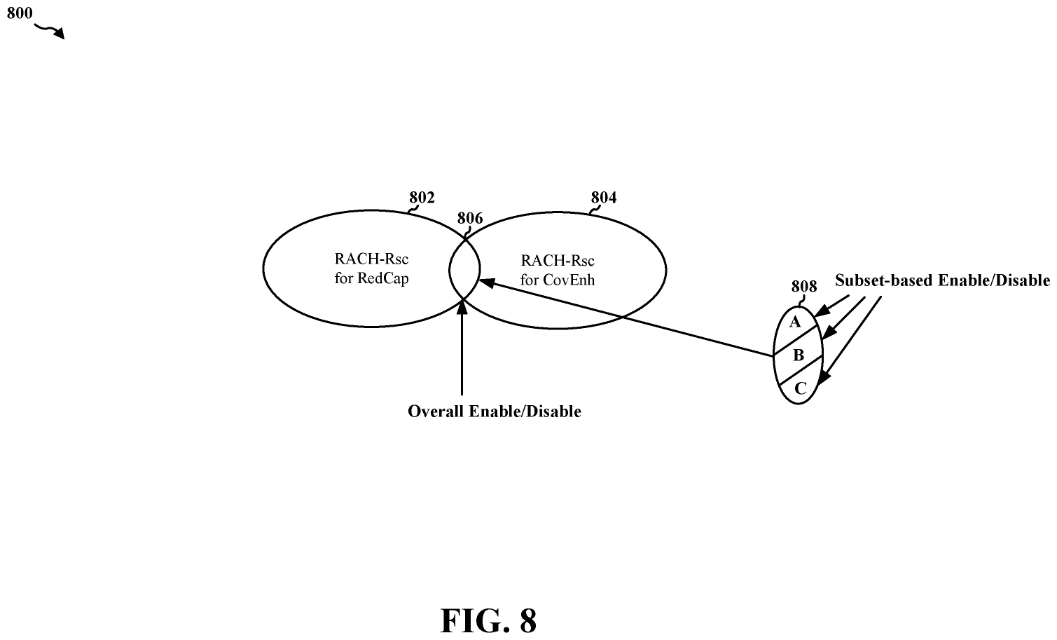

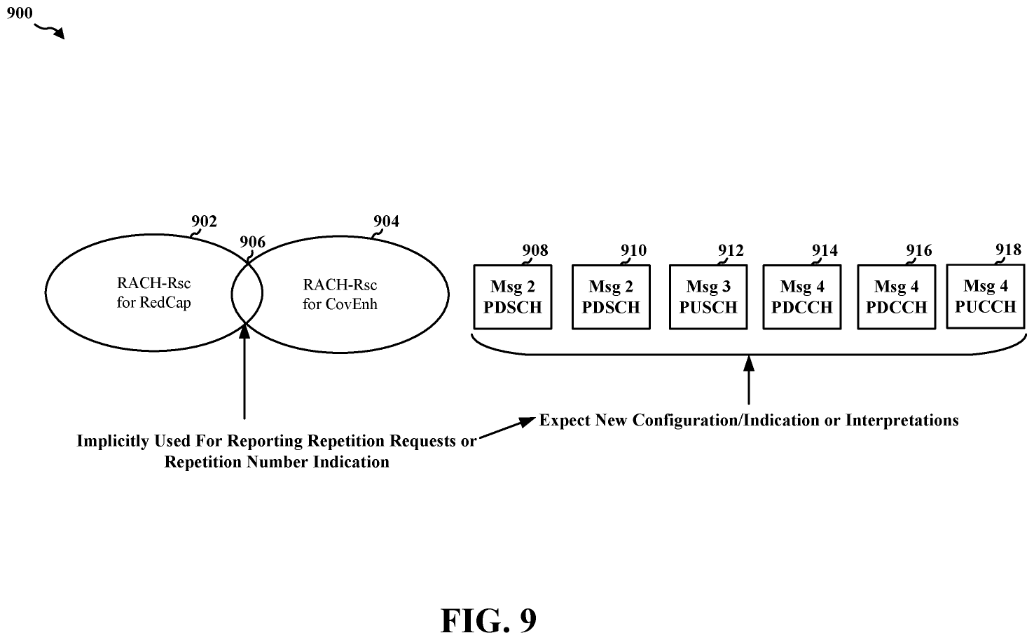

In some aspects, the UE 602 may be enabled or disabled from using the overlapping resources between RACH resources for RedCap and RACH resources for coverage enhancement to indicate repetition. For example, the base station 604 may transmit the system information 601 to disable or enable using the overlapping resources between RACH resources for RedCap and RACH resources for coverage enhancement to indicate repetition. In another example, the base station may transmit another indication to disable or enable using the overlapping resources between RACH resources for RedCap and RACH resources for coverage enhancement to indicate repetition. For example, as illustrated in example 800 of FIG. 8, the UE 602 may use overlapping resources 806 between RACH resources 802 for RedCap and RACH resources 804 for coverage enhancement to indicate repetition. In some aspects, using the overlapping resources 806 to indicate repetition may be enabled or disabled based on a base station configuration (e.g., configured by the base station 604). In some aspects, the base station configuration enabling or disabling using the overlapping resources 806 to indicate repetition may apply to all resources in the overlapping resources 806. In some aspects, the overlapping resources may include more than one RACH resource subsets. Each of the more than one RACH resource subsets may be associated with one or more different implicit additional repetition requests or repetition number indication respectively. For example, a first subset of the more than one RACH resource subsets may be associated with a Msg 2 PDCCH/PDSCH repetition request, a second subset of the more than one RACH resource subsets may be associated with a Msg 4 PDCCH/PDSCH/PUCCH repetition request, or the like. In some aspects, each subset of the more than one RACH resource subsets in the overlapping resources 806 may be further configured by a base station (e.g., the base station 604) to be enabled or disabled for the associated repetition requests or repetition number indications. As further illustrated in FIG. 9, the overlapping resources 806 may include more than one RACH resource subsets 808, which may include subset A, subset B, and subset C. Each of the subsets, e.g., any of subset A, subset B, and/or subset C, may be individually enabled or disabled for the associated repetition requests or repetition number indications. If a subset is disabled for the associated repetition requests or repetition number indications, the subset may be used for a RedCap capabilities report and a Msg 3 PUSCH repetition request, and the base station will not interpret use of the disabled resource to indicate a repetition request for a Msg 2 or Msg 4 or as a repetition number preference.

In some aspects, the UE 602 may be configured by the base station 604 to determine whether it may access the overlapping resources for implicitly indicating repetition requests or repetition numbers. In some aspects, the UE 602 may be configured to determine whether it may access the overlapping resources for implicitly indicating repetition requests or repetition numbers without any signaling from a base station.

In some aspects, if the UE 602 is a RedCap UE reporting one or more reduced capabilities in the first random access message 603 and does not include one or more of: 1) a reduced number of reception antennas or 2) a reduced reception antenna gain, the UE 602 may be configured, such as configured by the base station 604 or configured without base station signaling, to refrain from using the overlapping resources to report DL repetition requests or repetition number indications. In some aspects, if the UE 602 is a RedCap UE reporting one or more reduced capabilities in the first random access message 603 and does not include one or more of: 1) a reduced number of transmission antennas or 2) a reduced transmission antenna gain, the UE 602 may be configured, such as configured by the base station 604 or configured without base station signaling, to refrain from using the overlapping resources to report UL repetition requests or repetition number indications. In some aspects, if the UE 602 is not reporting reduced capabilities in the first random access message 603 and request Msg 3 PUSCH repetitions in the first random access message 603, the UE 602 may be configured, such as configured by the base station 604 or configured without base station signaling, to refrain from using the overlapping resources to report additional (other than Msg 3 PUSCH repetition request) repetition requests or number indications.

In some aspects, the set of RACH resources may be partitioned for at least two different types of usages (e.g., at least two different categories or types of repetition requests, repetition number indications, or capability reports). In some aspects, the partition may be based on partitioning RACH preambles for the at least 2 types of usages and sharing a number of ROs among the at least two types of usages. The partitioned RACH preambles may overlap. In some aspects, the partition may be based on partitioning a number of ROs for the at least two types of usages and sharing a number of RACH preambles among the at least two types of usages. The partitioned ROs may overlap.

Based on the repetition request or repetition number indication 603A, the rest of the messages in the RACH procedure, such as Msg 2, Msg 3, or Msg 4 may be adjusted accordingly. For example, as illustrated in example 900 of FIG. 9, the UE 602 may use overlapping resources 906 between RACH resources 902 for RedCap and RACH resources 904 for coverage enhancement to indicate repetition. The overlapping resources 906 may be used to implicitly indicate additional repetition requests or repetition number indications for Msg 2 PDSCH 908 and 910, Msg 3 PUSCH 912, Msg 4 PDCCH 914 and 916, or Msg 4 PUCCH 918.

The base station 604 may respond to the first random access message 403 by sending a second random access message 405 (e.g., Msg 2) using PDSCH and including a RAR. The RAR may include, e.g., an identifier of the RACH preamble sent by the UE, a TA, an uplink grant for the UE 602 to transmit data, C-RNTI, or other identifiers, and/or a back-off indicator. The second random access message 605 may be associated with a PDCCH or a PDSCH. In some aspects, if the UE 602 transmitted implicit DL repetition requests for Msg 2 PDCCH/PDSCH in the repetition request or repetition number indication 603A, the UE 602 may expect a RAR window-length, one or more RAR window-masks, or an RA-RNTI associated with the second random access message 405 (e.g., Msg 2 PDCCH) to be associated with one or more repetitions based on the repetition request or repetition number indication 603A. In some aspects, if the UE transmitted implicit DL repetition number indication for Msg 2 PDCCH, the one or more repetitions may include a number of repetitions based on the repetition number indication.

In some aspects, if the UE 602 transmitted implicit DL repetition requests for Msg 2 PDSCH in the repetition request or repetition number indication 603A, the UE 602 may expect to interpret the DCI decoded from the second random access message 405 (e.g., Msg 2 PDCCH) to include with one or more repetitions based on the repetition request or repetition number indication 603A.

In some aspects, if the UE 602 transmitted Msg 3 PUSCH repetition number indication in the repetition request or repetition number indication 603A, the UE 602 may expect the UL grant associated with the RAR in the second random access message 605 (e.g., Msg 2 PDCCH) to indicate a number of repetitions based on the repetition request or repetition number indication 603A. The number of repetitions may be further based on a configuration without base station signaling or based on the base station. For example, the UE 602 transmitted Msg 3 PUSCH repetition number indication as 4, the UL grant associated with the RAR may use 2-bits to indicate a repetition number of {1, 2, 4, 8} (one may be chosen by the UE 602 from the list). If the UE 602 transmitted Msg 3 PUSCH repetition number indication as 8, the UL grant associated with the RAR may use 2-bits to indicate a repetition number of {2, 4, 8, 16}.

In some aspects, if the UE 602 transmitted Msg 4 PDCCH, PDSCH, or PUCCH repetition number indication in the repetition request or repetition number indication 603A, the UE 602 may expect that the second random access message 405 (e.g., Msg 2 PDCCH) to indicate whether the Msg 4 PDCCH, PDSCH, or PUCCH in a fourth random access message 609 may include the repetitions or not.

In some aspects, the UE 602 may transmit the repetition request without a number indication. In some aspects, the second random access message 405 may indicate whether the UE 602 may expect further information on the number of repetitions for the Msg 4 PDCCH, PDSCH, or PUCCH associated with the fourth random access message 609 may be present in a third random access message 607. In some aspects, the third random access message 607 may also include an RRC connection request, an RRC connection re-establishment request, or an RRC connection resume request, depending on the trigger for initiating the random access procedure. In some aspects, the second random access message 405 may not indicate whether the UE 602 may expect further information on the number of repetitions for the Msg 4 PDCCH, PDSCH, or PUCCH in the fourth random access message 609 may be present in a third random access message 607. The UE 602 may expect the information on the number of repetitions for the Msg 4 PDCCH, PDSCH, or PUCCH associated with the fourth random access message 609 in the third random access message 607 based on the indication or independent of the indication. In some aspects, the third random access message 607 may not include the information on the number of repetitions for the Msg 4 PDCCH, PDSCH, or PUCCH associated with the fourth random access message 609, and the UE 602 may expect a number of repetitions for the Msg 4 PDCCH, PDSCH, or PUCCH associated with the fourth random access message 609. In some aspects, the fourth random access message 609 may also include a random access response message that includes timing advancement information, contention resolution information, or RRC connection setup information.

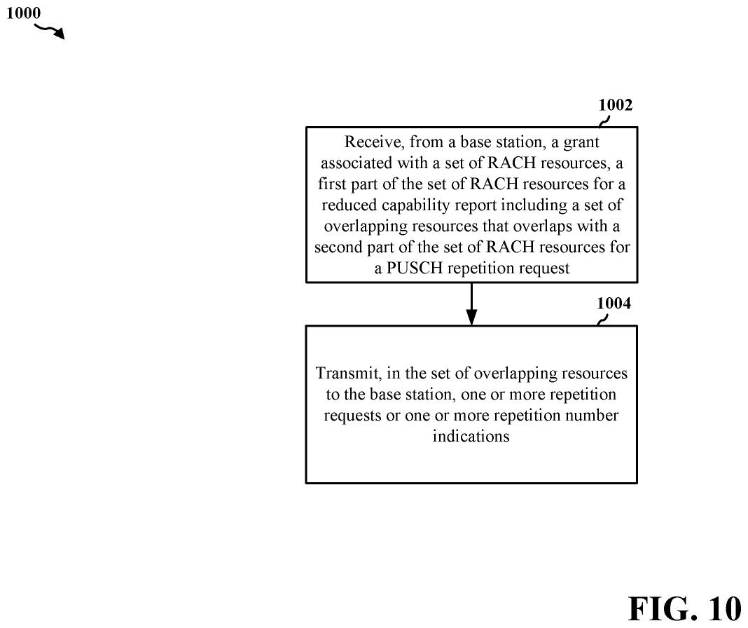

FIG. 10 is a flowchart 1000 of a method of wireless communication. The method may be performed by a UE (e.g., the UE 104, the UE 602; the apparatus 1402). The method may be used to reduce signaling overhead for a RedCap UE.

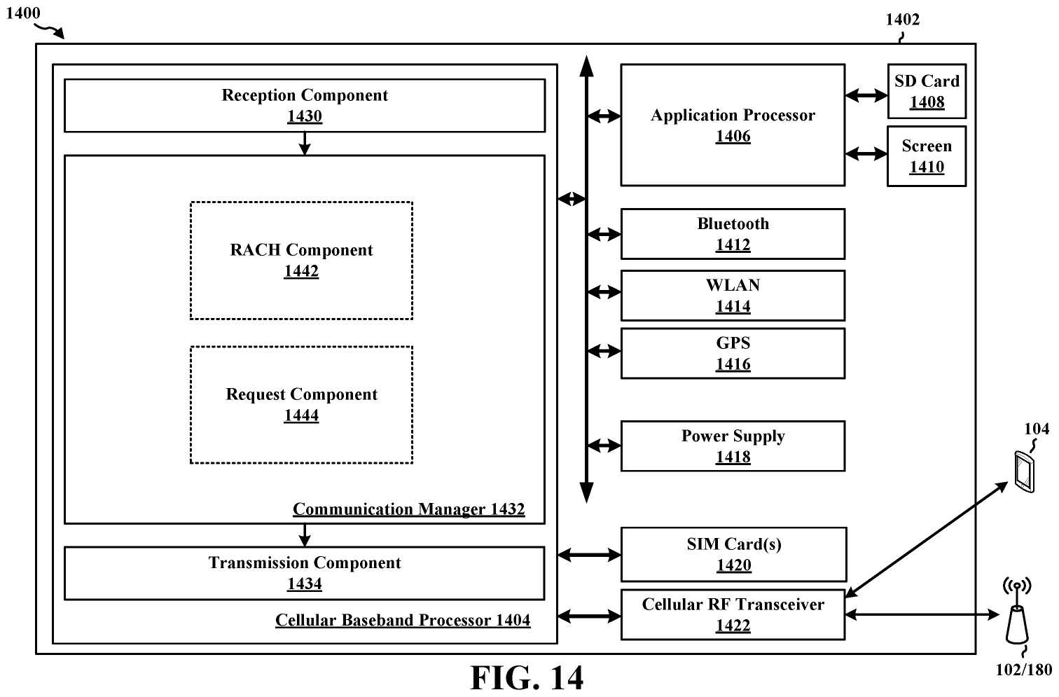

At 1002, the UE may receive, from a base station, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. For example, the UE 602 may receive, from a base station 604, a set of RACH resources, a first part of the set of RACH resources for a reduced capability report including a set of overlapping resources that overlaps with a second part of the set of RACH resources for a PUSCH repetition request. In some aspects, 1002 may be performed by RACH component 1442 of FIG. 14.

At 1004, the UE may transmit, in the set of overlapping resources to the base station, one or more repetition requests or one or more repetition number indications. For example, the UE 602 may transmit, in the set of overlapping resources to the base station 604, one or more repetition requests or one or more repetition number indications 603A. In some aspects, 1004 may be performed by request component 1444 of FIG. 14.

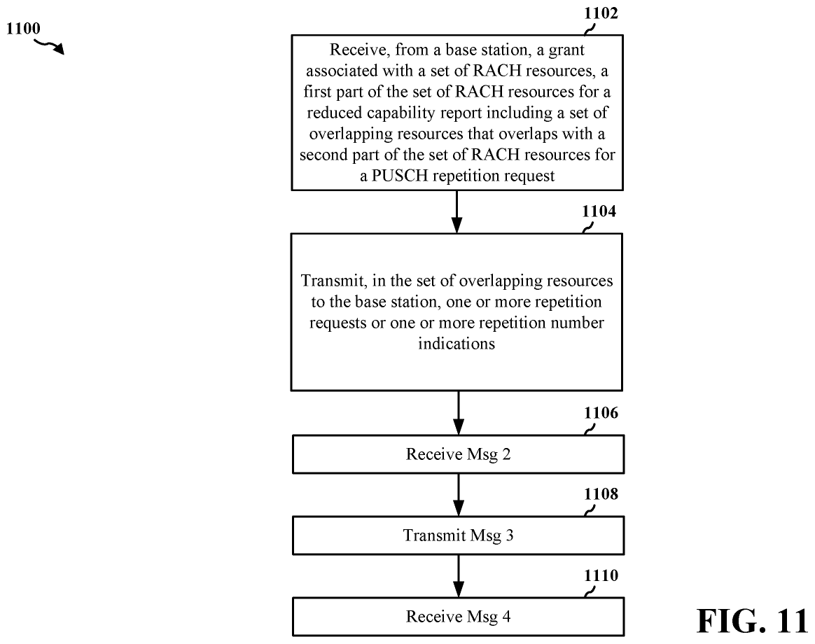

FIG. 11 is a flowchart 1100 of a method of wireless communication. The method may be performed by a UE (e.g., the UE 104, the UE 602; the apparatus 1402). The method may be used to reduce signaling overhead for a RedCap UE.

At 1102, the UE may receive, from a base station, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. For example, the UE 602 may receive, from a base station 604, a set of RACH resources, a first part of the set of RACH resources for a reduced capability report including a set of overlapping resources that overlaps with a second part of the set of RACH resources for a PUSCH repetition request. In some aspects, 1102 may be performed by RACH component 1442 of FIG. 14. In some aspects, as part of 1102, the UE may further receive, from the base station, a configuration enabling or disabling transmission of the one or more repetition requests or the one or more repetition number indications in the set of overlapping resources. In some aspects, as part of 1102, the UE may further receive, from the base station, a configuration individually enabling or disabling transmission of the at least one distinct repetition request or the at least one distinct repetition number indication for each of the more than one RACH resource subsets.

At 1104, the UE may transmit, in the set of overlapping resources to the base station, one or more repetition requests or one or more repetition number indications. For example, the UE 602 may transmit, in the set of overlapping resources to the base station 604, one or more repetition requests or one or more repetition number indications 603A. In some aspects, 1104 may be performed by request component 1444 of FIG. 14. In some aspects, the one or more repetition requests or the one or more repetition number indications comprise one or more of: a RACH Msg 2 or Msg 4 PDCCH repetition request, a RACH Msg 2 or Msg 4 PDCCH repetition number indication, a RACH Msg 2 or Msg 4 PDSCH repetition request, a RACH Msg 2 or Msg 4 PDSCH repetition number indication, a RACH Msg 3 PUSCH repetition request, a RACH Msg 4 PUCCH repetition request, or a RACH Msg 4 PUCCH repetition number indication. In some aspects, the set of overlapping resources includes more than one RACH resource subsets, each of the more than one RACH resource subsets may be associated with at least one distinct repetition request or at least one distinct repetition number indication of the one or more repetition requests or the one or more repetition number indications. In some aspects, the UE may transmit, in the set of overlapping resources, the one or more repetition requests or the one or more repetition number indications based on a configuration or a condition enabling use of the set of overlapping resources. In some aspects, the configuration or condition may be configured by a base station. In some aspects, the configuration or condition may be independent of the base station and not configured by the base station.

In some aspects, the configuration enables the UE to transmit the one or more repetition requests or the one or more repetition number indications in the set of overlapping resources if the UE is associated with at least one of a reduced reception antenna number or a reduced reception antenna gain. The configuration may further indicate for the UE not to transmit the one or more repetition requests or the one or more repetition number indications in the set of overlapping resources if the UE is not associated with the at least one of the reduced reception antenna number or the reduced reception antenna gain.

In some aspects, the configuration may enable the UE to transmit the one or more repetition requests or the one or more repetition number indications in the set of overlapping resources if the UE is associated with at least one of a reduced transmission antenna number or a reduced transmission antenna gain. The configuration may indicate for the UE not to transmit the one or more repetition requests or the one or more repetition number indications in the set of overlapping resources if the UE is not associated with the at least one of the reduced transmission antenna number or the reduced transmission antenna gain.

In some aspects, the configuration enables the UE to transmit the one or more repetition requests or the one or more repetition number indications in the set of overlapping resources if the UE is associated with a reduced capability. The configuration may indicate for the UE not to transmit the one or more repetition requests or the one or more repetition number indications in the set of overlapping resources if the UE is not associated with the reduced capability. In some aspects, a reduced capability associated with the reduced capability report includes one or more of: a reduced bandwidth, a reduced transmission antenna number, a reduced transmission antenna gain, a reduced reception antenna number, a reduced reception antenna gain, a reduced number of reception antenna chains, an HD-FDD, a reduced HARQ processing capability, a reduced CSI processing capability, or a reduced beam management capability. In some aspects, the set of RACH resources include at least one of one or more ROs or one or more RACH preambles. In some aspects, the one or more RACH preambles are overlappingly partitioned among the first part of the set of RACH resources and the second part of the set of RACH resources and the one or more ROs are shared among the first part of the set of RACH resources and the second part of the set of RACH resources. In some aspects, the one or more ROs are overlappingly partitioned among the first part of the set of RACH resources and the second part of the set of RACH resources and the one or more RACH preambles are shared among the first part of the set of RACH resources and the second part of the set of RACH resources

At 1106, the UE may receive Msg 2 from the base station based on the one or more repetition requests or the one or more repetition number indications. At 1108, the UE may transmit Msg 3 to the base station based on the one or more repetition requests or the one or more repetition number indications. At 1110, the UE may receive Msg 4 from the base station based on the one or more repetition requests or the one or more repetition number indications. For example, the UE 602 may receive the second random access message 605, transmit the third random access message 607, or receive the fourth random access message 609 associated with one or more repetitions. In some aspects, 1106, 1108, and 1110 may be performed by RACH component 1442 of FIG. 14.

In some aspects, the one or more repetition requests or the one or more repetition number indications includes a RACH Msg 2 PDCCH repetition request or a RACH Msg 2 PDSCH repetition request. The UE may receive, from the base station, a Msg 2 PDCCH associated with a RAR window length, one or more RAR window masks, or a RA-RNTI, the RAR window length, the one or more RAR window masks, or the RA-RNTI may be associated with the RACH Msg 2 PDCCH repetition request or the RACH Msg 2 PDSCH repetition request.

In some aspects, the one or more repetition requests or the one or more repetition number indications includes a RACH Msg 2 PDCCH repetition number indication. The UE may receive, from the base station, one or more repetitions of the PDCCH based on the RACH Msg 2 PDCCH repetition number indication.

In some aspects, the one or more repetition requests or the one or more repetition number indications includes the RACH Msg 2 PDSCH repetition request. The UE may receive, from the base station, a PDCCH associated with a DCI including one or more repetitions based on the RACH Msg 2 PDSCH repetition request.

In some aspects, the one or more repetition requests or the one or more repetition number indications includes a RACH Msg 3 PUSCH repetition number indication. The UE may receive, from the base station, a RACH Msg 2 PDSCH including a RAR UL grant indicating one or more repetitions for the RACH Msg 3 PUSCH, the one or more repetitions may be based on the RACH Msg 3 PUSCH repetition number indication.

In some aspects, the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication. The UE may receive, from the base station, a RACH Msg 2 indicating whether Msg 4 PDCCH repetition, Msg 4 PDSCH repetition, or Msg PUCCH repetition is expected.

In some aspects, the one or more repetition requests or the one or more repetition number indications includes one or more of: a RACH Msg 4 PDCCH repetition request without number indication, a RACH Msg 4 PDSCH repetition request without number indication, or a RACH Msg 4 PUCCH repetition request without number indication. The UE may transmit, to the base station, a RACH Msg 3 indicating the number indication associated with the Msg 4 PDCCH, the Msg 4 PDSCH, or the Msg 4 PUCCH.

In some aspects, the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication. The UE may receive, from the base station, the RACH Msg 4 PDCCH, the RACH Msg 4 PDSCH, or the RACH Msg 4 PUCCH with a number of repetitions based on the one or more repetition requests or the one or more repetition number indications.

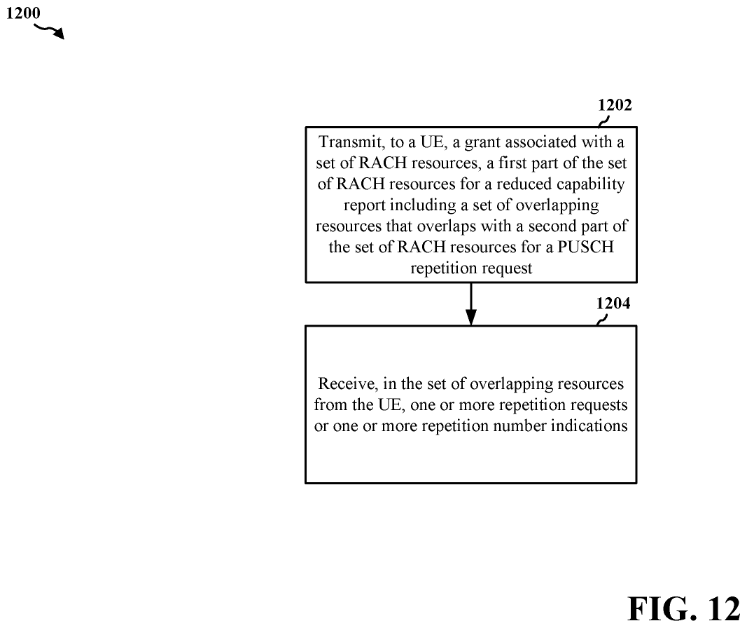

FIG. 12 is a flowchart 1200 of a method of wireless communication. The method may be performed by a base station (e.g., the base station 122/180, the base station 604; the apparatus 1502). The method may be used to reduce signaling overhead for a RedCap UE.

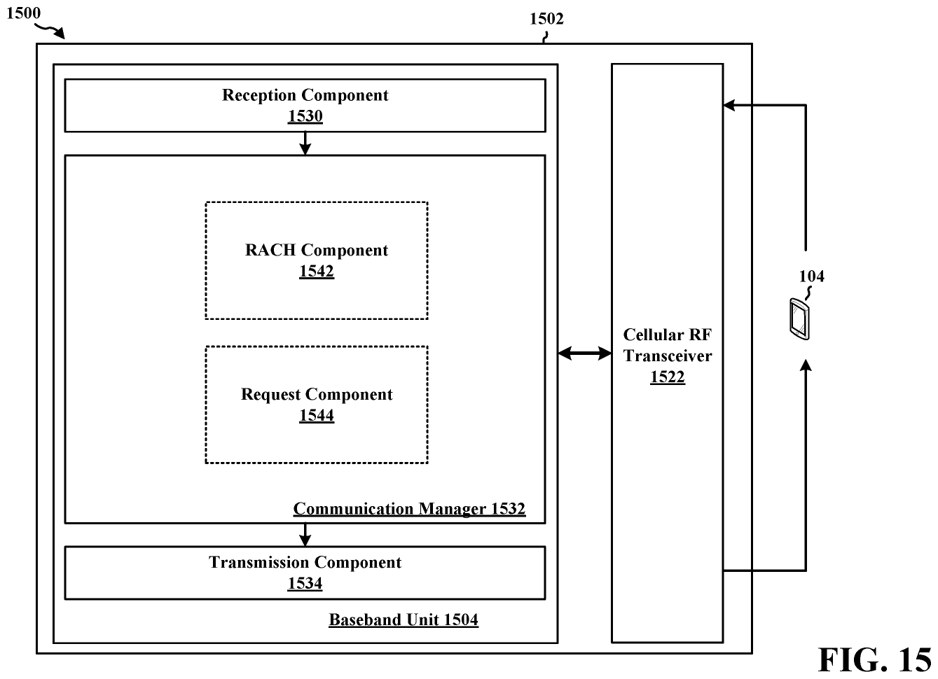

At 1202, the base station may transmit, to a UE, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. For example, the base station 604 may transmit, to a UE 602, a set of RACH resources, a first part of the set of RACH resources for a reduced capability report including a set of overlapping resources that overlaps with a second part of the set of RACH resources for a PUSCH repetition request. In some aspects, 1202 may be performed by RACH component 1542 of FIG. 15.

At 1204, the base station may receive, in the set of overlapping resources from the UE, one or more repetition requests or one or more repetition number indications. For example, the base station 604 may receive, in the set of overlapping resources from the UE 602, one or more repetition requests or one or more repetition number indications 603A. In some aspects, 1204 may be performed by request component 1544 of FIG. 15.

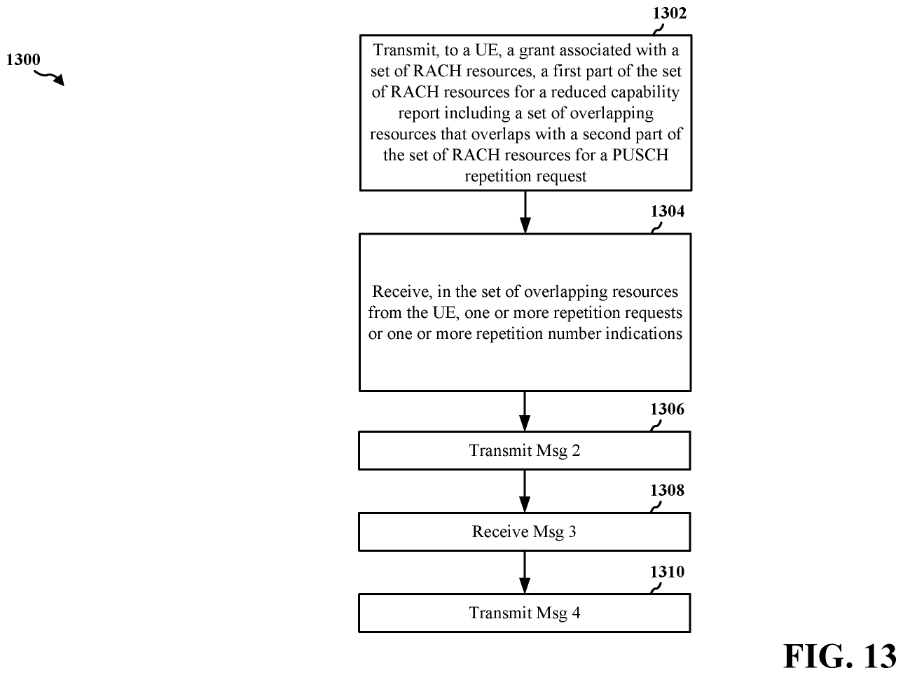

FIG. 13 is a flowchart 1300 of a method of wireless communication. The method may be performed by a base station (e.g., the base station 122/180, the base station 604; the apparatus 1502). The method may be used to reduce signaling overhead for a RedCap UE.

At 1302, the base station may transmit, to a UE, a grant associated with a set of RACH resources, a first part of the set of RACH resources for a reduced capability report including a set of overlapping resources that overlaps with a second part of the set of RACH resources for a PUSCH repetition request. In some aspects, each of the one or more repetition number indications is associated with a requested number of repetitions. For example, the base station 604 may transmit, to a UE 602, a set of RACH resources, a first part of the set of RACH resources for a reduced capability report including a set of overlapping resources that overlaps with a second part of the set of RACH resources for a PUSCH repetition request. In some aspects, 1302 may be performed by RACH component 1542 of FIG. 15. In some aspects, as part of 1302, the base station may further transmit, to the UE, a configuration enabling or disabling transmission of the one or more repetition requests or the one or more repetition number indications in the set of overlapping resources. In some aspects, as part of 1302, the base station may further transmit, to the UE, a configuration individually enabling or disabling transmission of the at least one distinct repetition request or the at least one distinct repetition number indication for each of the more than one RACH resource subsets.

At 1304, the base station may receive, in the set of overlapping resources from the UE, one or more repetition requests or one or more repetition number indications. For example, the base station 604 may receive, in the set of overlapping resources from the UE 602, one or more repetition requests or one or more repetition number indications 603A. In some aspects, 1304 may be performed by request component 1544 of FIG. 15. In some aspects, the one or more repetition requests or the one or more repetition number indications comprise one or more of: a RACH Msg 2 or Msg 4 PDCCH repetition request, a RACH Msg 2 or Msg 4 PDCCH repetition number indication, a RACH Msg 2 or Msg 4 PDSCH repetition request, a RACH Msg 2 or Msg 4 PDSCH repetition number indication, a RACH Msg 3 PUSCH repetition request, a RACH Msg 4 PUCCH repetition request, or a RACH Msg 4 PUCCH repetition number indication. In some aspects, the set of overlapping resources includes more than one RACH resource subsets, each of the more than one RACH resource subsets may be associated with at least one distinct repetition request or at least one distinct repetition number indication of the one or more repetition requests or the one or more repetition number indications. In some aspects, the base station may receive, in the set of overlapping resources, the one or more repetition requests or the one or more repetition number indications based on a configuration or a condition enabling use of the set of overlapping resources. In some aspects, the configuration or condition may be configured by a base station. In some aspects, the configuration or condition may be independent of the base station and not configured by the base station.

In some aspects, the configuration enables the UE to transmit the one or more repetition requests or the one or more repetition number indications in the set of overlapping resources if the UE is associated with at least one of a reduced reception antenna number or a reduced reception antenna gain. The configuration may further indicate for the UE not to transmit the one or more repetition requests or the one or more repetition number indications in the set of overlapping resources if the UE is not associated with the at least one of the reduced reception antenna number or the reduced reception antenna gain.

In some aspects, the configuration may enable the UE to transmit the one or more repetition requests or the one or more repetition number indications in the set of overlapping resources if the UE is associated with at least one of a reduced transmission antenna number or a reduced transmission antenna gain. The configuration may indicate for the UE not to transmit the one or more repetition requests or the one or more repetition number indications in the set of overlapping resources if the UE is not associated with the at least one of the reduced transmission antenna number or the reduced transmission antenna gain.

In some aspects, the configuration enables the UE to transmit the one or more repetition requests or the one or more repetition number indications in the set of overlapping resources if the UE is associated with a reduced capability. The configuration may indicate for the UE not to transmit the one or more repetition requests or the one or more repetition number indications in the set of overlapping resources if the UE is not associated with the reduced capability. In some aspects, a reduced capability associated with the reduced capability report includes one or more of: a reduced bandwidth, a reduced transmission antenna number, a reduced transmission antenna gain, a reduced reception antenna number, a reduced reception antenna gain, a reduced number of reception antenna chains, an HD-FDD, a reduced HARQ processing capability, a reduced CSI processing capability, or a reduced beam management capability. In some aspects, the set of RACH resources include at least one of one or more ROs or one or more RACH preambles. In some aspects, the one or more RACH preambles are overlappingly partitioned among the first part of the set of RACH resources and the second part of the set of RACH resources and the one or more ROs are shared among the first part of the set of RACH resources and the second part of the set of RACH resources. In some aspects, the one or more ROs are overlappingly partitioned among the first part of the set of RACH resources and the second part of the set of RACH resources and the one or more RACH preambles are shared among the first part of the set of RACH resources and the second part of the set of RACH resources

At 1308, the base station may transmit Msg 2 from the base station based on the one or more repetition requests or the one or more repetition number indications. At 1308, the base station may receive Msg 3 from the UE based on the one or more repetition requests or the one or more repetition number indications. At 1310, the base station may transmit Msg 4 from the base station based on the one or more repetition requests or the one or more repetition number indications. For example, the base station 604 may transmit the second random access message 605, receive the third random access message 607, or transmit the fourth random access message 609 associated with one or more repetitions. In some aspects, 1306, 1308, and 1310 may be performed by RACH component 1542 of FIG. 15.

In some aspects, the one or more repetition requests or the one or more repetition number indications includes a RACH Msg 2 PDCCH repetition request or a RACH Msg 2 PDSCH repetition request. The base station may transmit, to the UE, a Msg 2 PDCCH associated with a RAR window length, one or more RAR window masks, or a RA-RNTI, the RAR window length, the one or more RAR window masks, or the RA-RNTI may be associated with the RACH Msg 2 PDCCH repetition request or the RACH Msg 2 PDSCH repetition request.

In some aspects, the one or more repetition requests or the one or more repetition number indications includes a RACH Msg 2 PDCCH repetition number indication. The base station may transmit, to the UE, one or more repetitions of the PDCCH based on the RACH Msg 2 PDCCH repetition number indication.

In some aspects, the one or more repetition requests or the one or more repetition number indications includes the RACH Msg 2 PDSCH repetition request. The base station may transmit, to the UE, a PDCCH associated with a DCI including one or more repetitions based on the RACH Msg 2 PDSCH repetition request.

In some aspects, the one or more repetition requests or the one or more repetition number indications includes a RACH Msg 3 PUSCH repetition number indication. The base station may transmit, to the UE, a RACH Msg 2 PDSCH including a RAR UL grant indicating one or more repetitions for the RACH Msg 3 PUSCH, the one or more repetitions may be based on the RACH Msg 3 PUSCH repetition number indication.

In some aspects, the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication. The base station may transmit, to the UE, a RACH Msg 2 indicating whether Msg 4 PDCCH repetition, Msg 4 PDSCH repetition, or Msg PUCCH repetition is expected.

In some aspects, the one or more repetition requests or the one or more repetition number indications includes one or more of: a RACH Msg 4 PDCCH repetition request without number indication, a RACH Msg 4 PDSCH repetition request without number indication, or a RACH Msg 4 PUCCH repetition request without number indication. The base station may receive, from the UE, a RACH Msg 3 indicating the number indication associated with the Msg 4 PDCCH, the Msg 4 PDSCH, or the Msg 4 PUCCH.

In some aspects, the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication. The base station may transmit, to the UE, the RACH Msg 4 PDCCH, the RACH Msg 4 PDSCH, or the RACH Msg 4 PUCCH with a number of repetitions based on the one or more repetition requests or the one or more repetition number indications.

FIG. 14 is a diagram 1400 illustrating an example of a hardware implementation for an apparatus 1402. The apparatus 1402 may be a UE, a component of a UE, or may implement UE functionality. In some aspects, the apparatus 1402 may include a cellular baseband processor 1404 (also referred to as a modem) coupled to a cellular RF transceiver 1422. In some aspects, the apparatus 1402 may further include one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, or a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the cellular baseband processor 1404, and in another configuration, the apparatus 1402 may be the entire UE (e.g., see 350 of FIG. 3) and include the additional modules of the apparatus 1402.

The communication manager 1432 may include a RACH component 1442 that is configured to receive, from a base station, a grant associated with a set of RACH resources, a first part of the set of RACH resources for a reduced capability report including a set of overlapping resources that overlaps with a second part of the set of RACH resources for a PUSCH repetition request, e.g., as described in connection with 1002 in FIG. 10, or 1102 in FIG. 11. In some aspects, the RACH component 1442 may be further configured to receive Msg 2, transmit Msg 3, or receive Msg 4, e.g., as described in connection with 1106, 1108, or 1110 in FIG. 11.

The communication manager 1432 may further include a request component 1444 that may be configured to transmit, in the set of overlapping resources to the base station, one or more repetition requests or one or more repetition number indications, e.g., as described in connection with 1004 in FIG. 10, or 1104 in FIG. 11.

The apparatus may include additional components that perform each of the blocks of the algorithm in the flowcharts of FIGS. 10-11. As such, each block in the flowcharts of FIGS. 10-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the cellular baseband processor 1404, may include means for receiving, from a base station, a grant associated with a set of RACH resources, a first part of the set of RACH resources for a reduced capability report including a set of overlapping resources that overlaps with a second part of the set of RACH resources for a PUSCH repetition request. The cellular baseband processor 1404 may further include means for transmitting, in the set of overlapping resources to the base station, one or more repetition requests or one or more repetition number indications. The cellular baseband processor 1404 may further include means for receiving, from the base station, a configuration enabling or disabling transmission of the one or more repetition requests or the one or more repetition number indications in the set of overlapping resources. The cellular baseband processor 1404 may further include means for receiving, from the base station, a configuration individually enabling or disabling transmission of the at least one distinct repetition request or the at least one distinct repetition number indication for each of the more than one RACH resource subsets. The cellular baseband processor 1404 may further include means for receiving, from the base station, a Msg 2 PDCCH associated with a RAR window length, one or more RAR window masks, or a RA-RNTI, the RAR window length, the one or more RAR window masks, or the RA-RNTI may be associated with the RACH Msg 2 PDCCH repetition request or the RACH Msg 2 PDSCH repetition request. The cellular baseband processor 1404 may further include means for receiving, from the base station, one or more repetitions of the PDCCH based on the RACH Msg 2 PDCCH repetition number indication. The cellular baseband processor 1404 may further include means for receiving, from the base station, a PDCCH associated with a DC) including one or more repetitions based on the RACH Msg 2 PDSCH repetition request. The cellular baseband processor 1404 may further include means for receiving, from the base station, a RACH Msg 2 PDSCH including a RAR UL grant indicating one or more repetitions for the RACH Msg 3 PUSCH, the one or more repetitions may be based on the RACH Msg 3 PUSCH repetition number indication. The cellular baseband processor 1404 may further include means for receiving, from the base station, a RACH Msg 2 indicating whether Msg 4 PDCCH repetition, Msg 4 PDSCH repetition, or Msg PUCCH repetition is expected. The cellular baseband processor 1404 may further include means for receiving, from the base station, a RACH Msg 2 indicating whether to transmit the number indication associated with the Msg 4 PDCCH, the Msg 4 PDSCH, or the Msg 4 PUCCH in a RACH Msg 3. The cellular baseband processor 1404 may further include means for transmitting, to the base station, a RACH Msg 3 indicating the number indication associated with the Msg 4 PDCCH, the Msg 4 PDSCH, or the Msg 4 PUCCH. The cellular baseband processor 1404 may further include means for receiving, from the base station, the RACH Msg 4 PDCCH, the RACH Msg 4 PDSCH, or the RACH Msg 4 PUCCH with a number of repetitions based on the one or more repetition requests or the one or more repetition number indications. The means may be one or more of the components of the apparatus 1402 configured to perform the functions recited by the means. As described supra, the apparatus 1402 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 15 is a diagram 1500 illustrating an example of a hardware implementation for an apparatus 1502. The apparatus 1502 may be a base station, a component of a base station, or may implement base station functionality. In some aspects, the apparatus 1402 may include a baseband unit 1504. The baseband unit 1504 may communicate through a cellular RF transceiver 1522 with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 310 and may include the memory 376 and/or at least one of the TX processor 316, the RX processor 370, and the controller/processor 375.

The communication manager 1532 may include a RACH component 1542 that may transmit, to a UE, a grant associated with a set of RACH resources, a first part of the set of RACH resources for a reduced capability report including a set of overlapping resources that overlaps with a second part of the set of RACH resources for a PUSCH repetition request, e.g., as described in connection with 1202 in FIG. 12, or 1302 in FIG. 13. The RACH component 1542 may be further configured to transmit Msg 2, receive Msg 3, or transmit Msg 4, e.g., as described in connection with 1306, 1308, or 1310 in FIG. 13.

The communication manager 1532 further may include a request component 1544 that may receive, in the set of overlapping resources from the UE, one or more repetition requests or one or more repetition number indications, e.g., as described in connection with 1204 in FIG. 12, or 1304 in FIG. 13.

The apparatus may include additional components that perform each of the blocks of the algorithm in the flowcharts of FIGS. 12-13. As such, each block in the flowcharts of FIGS. 12-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the baseband unit 1504, may include means for transmitting, to a UE, a grant associated with a set of RACH resources, a first part of the set of RACH resources for a reduced capability report including a set of overlapping resources that overlaps with a second part of the set of RACH resources for a PUSCH repetition request. The baseband unit 1504 may further include means for receiving, in the set of overlapping resources from the UE, one or more repetition requests or one or more repetition number indications. The baseband unit 1504 may further include means for transmitting, to the UE, a Msg 2 PDCCH associated with a RAR window length, one or more RAR window masks, or a RA-RNTI, the RAR window length, the one or more RAR window masks, or the RA-RNTI being associated with the RACH Msg 2 PDCCH repetition request or the RACH Msg 2 PDSCH repetition request. The baseband unit 1504 may further include means for transmitting, to the UE, one or more repetitions of the PDCCH based on the RACH Msg 2 PDCCH repetition number indication. The baseband unit 1504 may further include means for transmitting, to the UE, a PDCCH associated with a DCI including one or more repetitions based on the RACH Msg 2 PDSCH repetition request. The baseband unit 1504 may further include means for transmitting, to the UE, a RACH Msg 2 PDSCH comprising a RAR UL grant indicating one or more repetitions for the RACH Msg 3 PUSCH, the one or more repetitions being based on the RACH Msg 3 PUSCH repetition number indication. The baseband unit 1504 may further include means for transmitting, to the UE, a RACH Msg 2 indicating whether Msg 4 PDCCH repetition, Msg 4 PDSCH repetition, or Msg PUCCH repetition is expected. The baseband unit 1504 may further include means for transmitting, to the UE, a RACH Msg 2 indicating whether to transmit the number indication associated with the Msg 4 PDCCH, the Msg 4 PDSCH, or the Msg 4 PUCCH in a RACH Msg 3. The baseband unit 1504 may further include means for receiving, from the UE, a RACH Msg 3 indicating the number indication associated with the Msg 4 PDCCH, the Msg 4 PDSCH, or the Msg 4 PUCCH. The baseband unit 1504 may further include means for transmitting, to the UE, the RACH Msg 4 PDCCH, the RACH Msg 4 PDSCH, or the RACH Msg 4 PUCCH with a number of repetitions based on the one or more repetition requests or the one or more repetition number indications. The baseband unit 1504 may further include means for receiving, from the base station, a configuration enabling or disabling transmission of the one or more repetition requests or the one or more repetition number indications in the set of overlapping resources. The baseband unit 1504 may further include means for receiving, from the base station, a configuration individually enabling or disabling transmission of the at least one distinct repetition request or the at least one distinct repetition number indication for each of the more than one RACH resource subsets. The means may be one or more of the components of the apparatus 1502 configured to perform the functions recited by the means. As described supra, the apparatus 1502 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a first UE, including: a memory; and at least one processor coupled to the memory and configured to: receive, from a base station, a grant associated with a set of RACH resources, a first part of the set of RACH resources for a reduced capability report including a set of overlapping resources that overlaps with a second part of the set of RACH resources for a PUSCH repetition request; and transmit, in the set of overlapping resources to the base station, one or more repetition requests or one or more repetition number indications, wherein each of the one or more repetition number indications is associated with a requested number of repetitions.

Aspect 2 is the apparatus of aspect 1, where the one or more repetition requests or the one or more repetition number indications comprise one or more of: a RACH Msg 2 or Msg 4 PDCCH repetition request, a RACH Msg 2 or Msg 4 PDCCH repetition number indication, a RACH Msg 2 or Msg 4 PDSCH repetition request, a RACH Msg 2 or Msg 4 PDSCH repetition number indication, a RACH Msg 3 PUSCH repetition request, a RACH Msg 4 PUCCH repetition request, or a RACH Msg 4 PUCCH repetition number indication.

Aspect 3 is the apparatus of any of aspects 1-2, where the at least one processor coupled to the memory is further configured to: receive, from the base station, a configuration enabling or disabling transmission of the one or more repetition requests or the one or more repetition number indications in the set of overlapping resources.

Aspect 4 is the apparatus of any of aspects 1-3, where the set of overlapping resources includes more than one RACH resource subsets, each of the more than one RACH resource subsets may be associated with at least one distinct repetition request or at least one distinct repetition number indication of the one or more repetition requests or the one or more repetition number indications.

Aspect 5 is the apparatus of any of aspects 1-4, where the at least one processor coupled to the memory is further configured to: receive, from the base station, a configuration individually enabling or disabling transmission of the at least one distinct repetition request or the at least one distinct repetition number indication for each of the more than one RACH resource subsets.

Aspect 6 is the apparatus of any of aspects 1-5, where the at least one processor coupled to the memory is configured to transmit, in the set of overlapping resources, the one or more repetition requests or the one or more repetition number indications based on a configuration or a condition enabling use of the set of overlapping resources.

Aspect 7 is the apparatus of any of aspects 1-6, where the configuration enables the UE to transmit the one or more repetition requests or the one or more repetition number indications in the set of overlapping resources if the UE is associated with at least one of a reduced reception antenna number or a reduced reception antenna gain, and where the configuration further indicates for the UE not to transmit the one or more repetition requests or the one or more repetition number indications in the set of overlapping resources if the UE is not associated with the at least one of the reduced reception antenna number or the reduced reception antenna gain.

Aspect 8 is the apparatus of any of aspects 1-7, where the configuration enables the UE to transmit the one or more repetition requests or the one or more repetition number indications in the set of overlapping resources if the UE is associated with at least one of a reduced transmission antenna number or a reduced transmission antenna gain, and where the configuration indicates for the UE not to transmit the one or more repetition requests or the one or more repetition number indications in the set of overlapping resources if the UE is not associated with the at least one of the reduced transmission antenna number or the reduced transmission antenna gain.

Aspect 9 is the apparatus of any of aspects 1-8, where the configuration enables the UE to transmit the one or more repetition requests or the one or more repetition number indications in the set of overlapping resources if the UE is associated with a reduced capability, and where the configuration indicates for the UE not to transmit the one or more repetition requests or the one or more repetition number indications in the set of overlapping resources if the UE is not associated with the reduced capability.

Aspect 10 is the apparatus of any of aspects 1-9, where a reduced capability associated with the reduced capability report includes one or more of: a reduced bandwidth, a reduced transmission antenna number, a reduced transmission antenna gain, a reduced reception antenna number, a reduced reception antenna gain, a reduced number of reception antenna chains, a half-duplex-frequency division duplex (HD-FDD), a reduced HARQ processing capability, a reduced CSI processing capability, or a reduced beam management capability.

Aspect 11 is the apparatus of any of aspects 1-10, where the set of RACH resources include at least one of one or more ROs or one or more RACH preambles.

Aspect 12 is the apparatus of any of aspects 1-11, wherein the one or more RACH preambles are overlappingly partitioned among the first part of the set of RACH resources and the second part of the set of RACH resources and the one or more ROs are shared among the first part of the set of RACH resources and the second part of the set of RACH resources, or the one or more ROs are overlappingly partitioned among the first part of the set of RACH resources and the second part of the set of RACH resources and the one or more RACH preambles are shared among the first part of the set of RACH resources and the second part of the set of RACH resources.

Aspect 13 is the apparatus of any of aspects 1-12, where the one or more repetition requests or the one or more repetition number indications includes a RACH Msg 2 PDCCH repetition request or a RACH Msg 2 PDSCH repetition request, and where the at least one processor coupled to the memory is further configured to: receive, from the base station, a Msg 2 PDCCH associated with a RAR window length, one or more RAR window masks, or a RA-RNTI, the RAR window length, the one or more RAR window masks, or the RA-RNTI may be associated with the RACH Msg 2 PDCCH repetition request or the RACH Msg 2 PDSCH repetition request.

Aspect 14 is the apparatus of any of aspects 1-13, where the one or more repetition requests or the one or more repetition number indications includes a RACH Msg 2 PDCCH repetition number indication, and where the at least one processor coupled to the memory is further configured to: receive, from the base station, one or more repetitions of the PDCCH based on the RACH Msg 2 PDCCH repetition number indication.

Aspect 15 is the apparatus of any of aspects 1-14, where the one or more repetition requests or the one or more repetition number indications includes the RACH Msg 2 PDSCH repetition request, and where the at least one processor coupled to the memory is further configured to: receive, from the base station, a PDCCH associated with a DCI including one or more repetitions based on the RACH Msg 2 PDSCH repetition request.

Aspect 16 is the apparatus of any of aspects 1-15, where the one or more repetition requests or the one or more repetition number indications includes a RACH Msg 3 PUSCH repetition number indication, and where the at least one processor coupled to the memory is further configured to: receive, from the base station, a RACH Msg 2 PDSCH including a RAR UL grant indicating one or more repetitions for the RACH Msg 3 PUSCH, the one or more repetitions may be based on the RACH Msg 3 PUSCH repetition number indication.

Aspect 17 is the apparatus of any of aspects 1-16, where the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication, and where the at least one processor coupled to the memory is further configured to: receive, from the base station, a RACH Msg 2 indicating whether Msg 4 PDCCH repetition, Msg 4 PDSCH repetition, or Msg PUCCH repetition is expected.

Aspect 18 is the apparatus of any of aspects 1-17, where the one or more repetition requests or the one or more repetition number indications includes one or more of: a RACH Msg 4 PDCCH repetition request without number indication, a RACH Msg 4 PDSCH repetition request without number indication, or a RACH Msg 4 PUCCH repetition request without number indication, and where the at least one processor coupled to the memory is further configured to: receive, from the base station, a RACH Msg 2 indicating whether to transmit the number indication associated with the Msg 4 PDCCH, the Msg 4 PDSCH, or the Msg 4 PUCCH in a RACH Msg 3.

Aspect 19 is the apparatus of any of aspects 1-18, where the one or more repetition requests or the one or more repetition number indications includes one or more of: a RACH Msg 4 PDCCH repetition request without number indication, a RACH Msg 4 PDSCH repetition request without number indication, or a RACH Msg 4 PUCCH repetition request without number indication, and where the at least one processor coupled to the memory is further configured to: transmit, to the base station, a RACH Msg 3 indicating the number indication associated with the Msg 4 PDCCH, the Msg 4 PDSCH, or the Msg 4 PUCCH.

Aspect 20 is the apparatus of any of aspects 1-19, where the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication, and where the at least one processor coupled to the memory is further configured to: receive, from the base station, the RACH Msg 4 PDCCH, the RACH Msg 4 PDSCH, or the RACH Msg 4 PUCCH with a number of repetitions based on the one or more repetition requests or the one or more repetition number indications.

Aspect 21 is the apparatus of any of aspects 1-20, further including a transceiver coupled to the at least one processor.

Aspect 22 is an apparatus for wireless communication at a base station, including: a memory; and at least one processor coupled to the memory and configured to: transmit, to a UE, a grant associated with a set of RACH resources, a first part of the set of RACH resources for a reduced capability report including a set of overlapping resources that overlaps with a second part of the set of RACH resources for a PUSCH repetition request; and receive, in the set of overlapping resources from the UE, one or more repetition requests or one or more repetition number indications, wherein each of the one or more repetition number indications is associated with a requested number of repetitions.

Aspect 23 is the apparatus of aspect 22, where the one or more repetition requests or the one or more repetition number indications includes a RACH Msg 2 PDCCH repetition request or a RACH Msg 2 PDSCH repetition request, and where the at least one processor coupled to the memory is further configured to: transmit, to the UE, a Msg 2 PDCCH associated with a RAR window length, one or more RAR window masks, or a RA-RNTI, the RAR window length, the one or more RAR window masks, or the RA-RNTI may be associated with the RACH Msg 2 PDCCH repetition request or the RACH Msg 2 PDSCH repetition request.

Aspect 24 is the apparatus of any of aspects 22-23, where the one or more repetition requests or the one or more repetition number indications includes a RACH Msg 2 PDCCH repetition number indication, and where the at least one processor coupled to the memory is further configured to: transmit, to the UE, one or more repetitions of the PDCCH based on the RACH Msg 2 PDCCH repetition number indication.

Aspect 25 is the apparatus of any of aspects 22-24, where the one or more repetition requests or the one or more repetition number indications includes the RACH Msg 2 PDSCH repetition request, and where the at least one processor coupled to the memory is further configured to: transmit, to the UE, a PDCCH associated with a DCI including one or more repetitions based on the RACH Msg 2 PDSCH repetition request.

Aspect 26 is the apparatus of any of aspects 22-25, where the one or more repetition requests or the one or more repetition number indications includes a RACH Msg 3 PUSCH repetition number indication, and where the at least one processor coupled to the memory is further configured to: transmit, to the UE, a RACH Msg 2 PDSCH including a RAR UL grant indicating one or more repetitions for the RACH Msg 3 PUSCH, the one or more repetitions may be based on the RACH Msg 3 PUSCH repetition number indication.

Aspect 27 is the apparatus of any of aspects 22-26, where the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication, and where the at least one processor coupled to the memory is further configured to: transmit, to the UE, a RACH Msg 2 indicating whether Msg 4 PDCCH repetition, Msg 4 PDSCH repetition, or Msg PUCCH repetition is expected.

Aspect 28 is the apparatus of any of aspects 22-27, where the one or more repetition requests or the one or more repetition number indications includes one or more of: a RACH Msg 4 PDCCH repetition request without number indication, a RACH Msg 4 PDSCH repetition request without number indication, or a RACH Msg 4 PUCCH repetition request without number indication, and where the at least one processor coupled to the memory is further configured to: transmit, to the UE, a RACH Msg 2 indicating whether to transmit the number indication associated with the Msg 4 PDCCH, the Msg 4 PDSCH, or the Msg 4 PUCCH in a RACH Msg 3.

Aspect 29 is the apparatus of any of aspects 22-28, where the one or more repetition requests or the one or more repetition number indications includes one or more of: a RACH Msg 4 PDCCH repetition request without number indication, a RACH Msg 4 PDSCH repetition request without number indication, or a RACH Msg 4 PUCCH repetition request without number indication, and where the at least one processor coupled to the memory is further configured to: receive, from the UE, a RACH Msg 3 indicating the number indication associated with the Msg 4 PDCCH, the Msg 4 PDSCH, or the Msg 4 PUCCH.

Aspect 30 is the apparatus of any of aspects 22-29, where the one or more repetition requests or the one or more repetition number indications includes one or more of: a RACH Msg 4 PDCCH repetition request, a RACH Msg 4 PDCCH repetition number indication, a RACH Msg 4 PDSCH repetition request, a RACH Msg 4 PDSCH repetition number indication, a RACH Msg 4 PUCCH repetition request, or a RACH Msg 4 PUCCH repetition number indication, and where the at least one processor coupled to the memory is further configured to: transmit, to the UE, the RACH Msg 4 PDCCH, the RACH Msg 4 PDSCH, or the RACH Msg 4 PUCCH with a number of repetitions based on the one or more repetition requests or the one or more repetition number indications.

Aspect 31 is the apparatus of any of aspects 22-30, further including a transceiver coupled to the at least one processor.

Aspect 32 is a method for wireless communication at a UE, including: receiving, from a base station, a set of RACH resources, a first part of the set of RACH resources for a reduced capability report including a set of overlapping resources that overlaps with a second part of the set of RACH resources for a PUSCH repetition request; and transmitting, in the set of overlapping resources to the base station, one or more repetition requests or one or more repetition number indications.

Aspect 33 is a method for wireless communication at a base station, including: transmitting, to a UE, a set of RACH resources, a first part of the set of RACH resources for a reduced capability report including a set of overlapping resources that overlaps with a second part of the set of RACH resources for a PUSCH repetition request; and receiving, in the set of overlapping resources from the UE, one or more repetition requests or one or more repetition number indications.

Aspect 34 is a method of wireless communication for implementing any of aspects 1 to 21.

Aspect 35 is an apparatus for wireless communication including means for implementing any of aspects 1 to 21.

Aspect 36 is a computer-readable medium storing computer executable code, where the code when executed by a processor causes the processor to implement any of aspects 1 to 21.

Aspect 37 is a method of wireless communication for implementing any of aspects 22 to 31.

Aspect 38 is an apparatus for wireless communication including means for implementing any of aspects 22 to 31.

Aspect 39 is a computer-readable medium storing computer executable code, where the code when executed by a processor causes the processor to implement any of aspects 22 to 31.

What is claimed is:

1. An apparatus for wireless communication at a first user equipment (UE), comprising:
a memory; and
at least one processor coupled to the memory and configured to:
receive, from a base station, a grant associated with a set of random access channel (RACH) resources, a first part of the set of RACH resources for a reduced capability report including a set of overlapping resources that overlaps with a second part of the set of RACH resources for a physical uplink shared channel (PUSCH) repetition request; and
transmit, in the set of overlapping resources to the base station, one or more repetition requests or one or more repetition number indications, wherein each of the one or more repetition number indications is associated with a requested number of repetitions.

2. The apparatus of claim 1, wherein the one or more repetition requests or the one or more repetition number indications comprise one or more of: a RACH Msg 2 or Msg 4 physical downlink control channel (PDCCH) repetition request, a RACH Msg 2 or Msg 4 PDCCH repetition number indication, a RACH Msg 2 or Msg 4 physical downlink shared channel (PDSCH) repetition request, a RACH Msg 2 or Msg 4 PDSCH repetition number indication, a RACH Msg 3 physical uplink shared channel (PUSCH) repetition request, a RACH Msg 4 physical uplink control channel (PUCCH) repetition request, or a RACH Msg 4 PUCCH repetition number indication.

3. The apparatus of claim 1, wherein the at least one processor coupled to the memory is further configured to:
receive, from the base station, a configuration enabling or disabling transmission of the one or more repetition requests or the one or more repetition number indications in the set of overlapping resources.

4. The apparatus of claim 1, wherein the set of overlapping resources comprises more than one RACH resource subsets, each of the more than one RACH resource subsets being associated with at least one distinct repetition request or at least one distinct repetition number indication of the one or more repetition requests or the one or more repetition number indications.

5. The apparatus of claim 4, wherein the at least one processor coupled to the memory is further configured to:
receive, from the base station, a configuration individually enabling or disabling transmission of the at least one distinct repetition request or the at least one distinct repetition number indication for each of the more than one RACH resource subsets.

6. The apparatus of claim 1, wherein the at least one processor coupled to the memory is configured to transmit, in the set of overlapping resources, the one or more repetition requests or the one or more repetition number indications based on a configuration or a condition enabling use of the set of overlapping resources.

7. The apparatus of claim 6, wherein the configuration enables the UE to transmit the one or more repetition requests or the one or more repetition number indications in the set of overlapping resources if the UE is associated with at least one of a reduced reception antenna number or a reduced reception antenna gain, and wherein the configuration further indicates for the UE not to transmit the one or more repetition requests or the one or more repetition number indications in the set of overlapping resources if the UE is not associated with the at least one of the reduced reception antenna number or the reduced reception antenna gain.

8. The apparatus of claim 6, wherein the configuration enables the UE to transmit the one or more repetition requests or the one or more repetition number indications in the set of overlapping resources if the UE is associated with at least one of a reduced transmission antenna number or a reduced transmission antenna gain, and wherein the configuration indicates for the UE not to transmit the one or more repetition requests or the one or more repetition number indications in the set of overlapping resources if the UE is not associated with the at least one of the reduced transmission antenna number or the reduced transmission antenna gain.

9. The apparatus of claim 6, wherein the configuration enables the UE to transmit the one or more repetition requests or the one or more repetition number indications in the set of overlapping resources if the UE is associated with a reduced capability, and wherein the configuration indicates for the UE not to transmit the one or more repetition requests or the one or more repetition number indications in the set of overlapping resources if the UE is not associated with the reduced capability.

10. The apparatus of claim 1, wherein a reduced capability associated with the reduced capability report comprises one or more of: a reduced bandwidth, a reduced transmission antenna number, a reduced transmission antenna gain, a reduced reception antenna number, a reduced reception antenna gain, a reduced number of reception antenna chains, a half-duplex-frequency division duplex (HD-FDD), a reduced hybrid automatic repeat request (HARQ) processing capability, a reduced channel state information (CSI) processing capability, or a reduced beam management capability.

11. The apparatus of claim 1, wherein the set of RACH resources comprise at least one of one or more RACH occasions (ROs) or one or more RACH preambles.

12. The apparatus of claim 11, wherein the one or more RACH preambles are overlappingly partitioned among the first part of the set of RACH resources and the second part of the set of RACH resources and the one or more ROs are shared among the first part of the set of RACH resources and the second part of the set of RACH resources, or the one or more ROs are overlappingly partitioned among the first part of the set of RACH resources and the second part of the set of RACH resources and the one or more RACH preambles are shared among the first part of the set of RACH resources and the second part of the set of RACH resources.

13. The apparatus of claim 1, wherein the one or more repetition requests or the one or more repetition number indications comprises a RACH Msg 2 physical downlink control channel (PDCCH) repetition request or a RACH Msg 2 physical downlink shared channel (PDSCH) repetition request, and wherein the at least one processor coupled to the memory is further configured to:
receive, from the base station, a Msg 2 PDCCH associated with a random access response (RAR) window length, one or more RAR window masks, or a random access radio network temporary identifier (RA-RNTI), the RAR window length, the one or more RAR window masks, or the RA-RNTI being associated with the RACH Msg 2 PDCCH repetition request or the RACH Msg 2 PDSCH repetition request.

14. The apparatus of claim 13, wherein the one or more repetition requests or the one or more repetition number indications comprises a RACH Msg 2 physical downlink control channel (PDCCH) repetition number indication, and wherein the at least one processor coupled to the memory is further configured to:
receive, from the base station, one or more repetitions of a PDCCH based on the RACH Msg 2 PDCCH repetition number indication.

15. The apparatus of claim 13, wherein the one or more repetition requests or the one or more repetition number indications comprises the RACH Msg 2 physical downlink shared channel (PDSCH) repetition request, and wherein the at least one processor coupled to the memory is further configured to:
receive, from the base station, a PDCCH associated with a downlink control information (DCI) including one or more repetitions based on the RACH Msg 2 PDSCH repetition request.

16. The apparatus of claim 1, wherein the one or more repetition requests or the one or more repetition number indications comprises a RACH Msg 3 physical uplink shared channel (PUSCH) repetition number indication, and wherein the at least one processor coupled to the memory is further configured to:
receive, from the base station, a RACH Msg 2 physical downlink shared channel (PDSCH) comprising a random access response (RAR) UL grant indicating one or more repetitions for the RACH Msg 3 PUSCH, the one or more repetitions being based on the RACH Msg 3 PUSCH repetition number indication.

17. The apparatus of claim 1, wherein the one or more repetition requests or the one or more repetition number indications comprises one or more of: a RACH Msg 4 physical downlink control channel (PDCCH) repetition request, a RACH Msg 4 PDCCH repetition number indication, a RACH Msg 4 physical downlink shared channel (PDSCH) repetition request, a RACH Msg 4 PDSCH repetition number indication, a RACH Msg 4 physical uplink control channel (PUCCH) repetition request, or a RACH Msg 4 PUCCH repetition number indication, and wherein the at least one processor coupled to the memory is further configured to:
receive, from the base station, a RACH Msg 2 indicating whether Msg 4 PDCCH repetition, Msg 4 PDSCH repetition, or Msg PUCCH repetition is expected.

18. The apparatus of claim 1, wherein the one or more repetition requests or the one or more repetition number indications comprises one or more of: a RACH Msg 4 physical downlink control channel (PDCCH) repetition request without a number indication, a RACH Msg 4 physical downlink shared channel (PDSCH) repetition request without the number indication, or a RACH Msg 4 physical uplink control channel (PUCCH) repetition request without the number indication, and wherein the at least one processor coupled to the memory is further configured to:
receive, from the base station, a RACH Msg 2 indicating whether to transmit the number indication associated with the RACH Msg 4 PDCCH, the RACH Msg 4 PDSCH, or the RACH Msg 4 PUCCH in a RACH Msg 3.

19. The apparatus of claim 1, wherein the one or more repetition requests or the one or more repetition number indications comprises one or more of: a RACH Msg 4 physical downlink control channel (PDCCH) repetition request without a number indication, a RACH Msg 4 physical downlink shared channel (PDSCH) repetition request without the number indication, or a RACH Msg 4 physical uplink control channel (PUCCH) repetition request without the number indication, and wherein the at least one processor coupled to the memory is further configured to:
transmit, to the base station, a RACH Msg 3 indicating the number indication associated with the RACH Msg 4 PDCCH, the RACH Msg 4 PDSCH, or the RACH Msg 4 PUCCH.

20. The apparatus of claim 1, wherein the one or more repetition requests or the one or more repetition number indications comprises one or more of: a RACH Msg 4 physical downlink control channel (PDCCH) repetition request, a RACH Msg 4 PDCCH repetition number indication, a RACH Msg 4 physical downlink shared channel (PDSCH) repetition request, a RACH Msg 4 PDSCH repetition number indication, a RACH Msg 4 physical uplink control channel (PUCCH) repetition request, or a RACH Msg 4 PUCCH repetition number indication, and wherein the at least one processor coupled to the memory is further configured to:
receive, from the base station, the RACH Msg 4 PDCCH, the RACH Msg 4 PDSCH, or the RACH Msg 4 PUCCH with a number of repetitions based on the one or more repetition requests or the one or more repetition number indications.

21. The apparatus of claim 1, further comprising a transceiver coupled to the at least one processor.

22. An apparatus for wireless communication at a base station, comprising:
a memory; and
at least one processor coupled to the memory and configured to:
transmit, to a user equipment (UE), a grant associated with a set of random access channel (RACH) resources, a first part of the set of RACH resources for a reduced capability report including a set of overlapping resources that overlaps with a second part of the set of RACH resources for a physical uplink shared channel (PUSCH) repetition request; and
receive, in the set of overlapping resources from the UE, one or more repetition requests or one or more repetition number indications, wherein each of the one or more repetition number indications is associated with a requested number of repetitions.

23. The apparatus of claim 22, wherein the one or more repetition requests or the one or more repetition number indications comprises a RACH Msg 2 physical downlink control channel (PDCCH) repetition request or a RACH Msg 2 physical downlink shared channel (PDSCH) repetition request, and wherein the at least one processor coupled to the memory is further configured to:
transmit, to the UE, a Msg 2 PDCCH associated with a random access response (RAR) window length, one or more RAR window masks, or a random access radio network temporary identifier (RA-RNTI), the RAR window length, the one or more RAR window masks, or the RA-RNTI being associated with the RACH Msg 2 PDCCH repetition request or the RACH Msg 2 PDSCH repetition request.

24. The apparatus of claim 23, wherein the one or more repetition requests or the one or more repetition number indications comprises a RACH Msg 2 physical downlink control channel (PDCCH) repetition number indication, and wherein the at least one processor coupled to the memory is further configured to:
transmit, to the UE, one or more repetitions of a PDCCH based on the RACH Msg 2 PDCCH repetition number indication.

25. The apparatus of claim 23, wherein the one or more repetition requests or the one or more repetition number indications comprises the RACH Msg 2 physical downlink shared channel (PDSCH) repetition request, and wherein the at least one processor coupled to the memory is further configured to:
transmit, to the UE, a PDCCH associated with a downlink control information (DCI) including one or more repetitions based on the RACH Msg 2 PDSCH repetition request.

26. The apparatus of claim 22, wherein the one or more repetition requests or the one or more repetition number indications comprises a RACH Msg 3 physical uplink shared channel (PUSCH) repetition number indication, and wherein the at least one processor coupled to the memory is further configured to:
transmit, to the UE, a RACH Msg 2 physical downlink shared channel (PDSCH) comprising a random access response (RAR) UL grant indicating one or more repetitions for the RACH Msg 3 PUSCH, the one or more repetitions being based on the RACH Msg 3 PUSCH repetition number indication.

27. The apparatus of claim 22, wherein the one or more repetition requests or the one or more repetition number indications comprises one or more of: a RACH Msg 4 physical downlink control channel (PDCCH) repetition request, a RACH Msg 4 PDCCH repetition number indication, a RACH Msg 4 physical downlink shared channel (PDSCH) repetition request, a RACH Msg 4 PDSCH repetition number indication, a RACH Msg 4 physical uplink control channel (PUCCH) repetition request, or a RACH Msg 4 PUCCH repetition number indication, and wherein the at least one processor coupled to the memory is further configured to:
transmit, to the UE, a RACH Msg 2 indicating whether Msg 4 PDCCH repetition, Msg 4 PDSCH repetition, or Msg PUCCH repetition is expected.

28. The apparatus of claim 22, wherein the one or more repetition requests or the one or more repetition number indications comprises one or more of: a RACH Msg 4 physical downlink control channel (PDCCH) repetition request without a number indication, a RACH Msg 4 physical downlink shared channel (PDSCH) repetition request without the number indication, or a RACH Msg 4 physical uplink control channel (PUCCH) repetition request without the number indication, and wherein the at least one processor coupled to the memory is further configured to:
transmit, to the UE, a RACH Msg 2 indicating whether to transmit the number indication associated with the RACH Msg 4 PDCCH, the RACH Msg 4 PDSCH, or the RACH Msg 4 PUCCH in a RACH Msg 3.

29. The apparatus of claim 22, wherein the one or more repetition requests or the one or more repetition number indications comprises one or more of: a RACH Msg 4 physical downlink control channel (PDCCH) repetition request without a number indication, a RACH Msg 4 physical downlink shared channel (PDSCH) repetition request without a number indication, or a RACH Msg 4 physical uplink control channel (PUCCH) repetition request without a number indication, and wherein the at least one processor coupled to the memory is further configured to:
receive, from the UE, a RACH Msg 3 indicating the number indication associated with the RACH Msg 4 PDCCH, the RACH Msg 4 PDSCH, or the RACH Msg 4 PUCCH.

30. The apparatus of claim 22, wherein the one or more repetition requests or the one or more repetition number indications comprises one or more of: a RACH Msg 4 physical downlink control channel (PDCCH) repetition request, a RACH Msg 4 PDCCH repetition number indication, a RACH Msg 4 physical downlink shared channel (PDSCH) repetition request, a RACH Msg 4 PDSCH repetition number indication, a RACH Msg 4 physical uplink control channel (PUCCH) repetition request, or a RACH Msg 4 PUCCH repetition number indication, and wherein the at least one processor coupled to the memory is further configured to:
transmit, to the UE, the RACH Msg 4 PDCCH, the RACH Msg 4 PDSCH, or the RACH Msg 4 PUCCH with a number of repetitions based on the one or more repetition requests or the one or more repetition number indications.

31. The apparatus of claim 22, further comprising a transceiver coupled to the at least one processor.

32. A method for wireless communication at a user equipment (UE), comprising:
receiving, from a base station, a grant associated with a set of random access channel (RACH) resources, a first part of the set of RACH resources for a reduced capability report including a set of overlapping resources that overlaps with a second part of the set of RACH resources for a physical uplink shared channel (PUSCH) repetition request; and
transmitting, in the set of overlapping resources to the base station, one or more repetition requests or one or more repetition number indications, wherein each of the one or more repetition number indications is associated with a requested number of repetitions.

33. A method for wireless communication at a base station, comprising:
transmitting, to a user equipment (UE), a grant associated with a set of random access channel (RACH) resources, a first part of the set of RACH resources for a reduced capability report including a set of overlapping resources that overlaps with a second part of the set of RACH resources for a physical uplink shared channel (PUSCH) repetition request; and
receiving, in the set of overlapping resources from the UE, one or more repetition requests or one or more repetition number indications, wherein each of the one or more repetition number indications is associated with a requested number of repetitions.
